(19) United States
(12) Patent Application Publication
(10) Pub. No.: US 2006/0114341 A1
(43) Pub. Date: Jun. 1, 2006

(54) Image capturing apparatus

(75) Inventors: Hideki Morinaga, Tokyo (JP); Tougo Teramoto, Wakayama-shi (JP); Kazuhiko Kojima, Osaka (JP); Hideaki Nakanishi, Osaka (JP); Hiroaki Hasegawa, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/287,040

(22) Filed: Nov. 22, 2005

(30) Foreign Application Priority Data
Nov. 26, 2004 (JP) 2004-341987

(51) Int. Cl. H04N 5/262

(52) U.S. Cl. 348/240.1

(57) ABSTRACT

An image capturing apparatus having an optical zooming lens which varies shooting magnification, an imaging sensor which captures image data of a subject image focused through the optical zooming lens, a zooming ring movable around a lens barrel containing the optical zooming lens for varying a focal length of the optical zooming lens, and a digital zooming portion which digitally enlarges the image data by reading a portion of the image data from the image data captured by the imaging sensor. In the above image capturing apparatus, the digital zooming portion is operated in response to a detection that the zooming ring reaches a predetermined position when a digital zooming instruction is input to the image capturing apparatus.

### CROSS-REFERENCE TO RELATED APPLICATION

This application is based on Japanese Patent Application No.2004-341987 filed in Japan on Nov. 26, 2004, the entire content of which is hereby incorporated by reference.

### BACKGROUND OF THE INVENTION

1. Field of the Invention

The present invention relates to an image capturing apparatus having optical zooming and digital zooming capabilities.

2. Description of the Related Art

In recent years, digital cameras which photograph subjects by capturing subject images as digital data by means of an imaging device such as a CCD or a CMOS have been spreading rapidly, replacing the traditional silver halide cameras which photograph subjects by exposing subject images onto silver halide film.

Digital cameras are known that have two different zooming functions, an optical zooming function which optically varies shooting magnification by moving an optical zooming lens relative to the camera body and thereby varying its focal length, and a digital zooming function which digitally enlarges a portion of an image by reading the portion of the image from the subject image captured by the imaging device. In this type of digital camera, since the digital zooming has the shortcoming that the image quality degrades due to reduced pixel resolution, it is usual practice to use the optical zooming in the magnification range that can be covered by the optical zooming, and to activate the digital zooming if a larger magnification is desired.

FIG. 1(a) shows a side view of a single-reflex digital camera 100 according to the prior art, and FIG. 1(b) shows a rear view of the single-reflex digital camera 100 in FIG. 1(a). The digital camera 100 comprises a camera body 112 as a camera casing, and a lens barrel 114 which contains an optical zooming lens. A built-in flash 116 which, when activated, automatically pops up to the position indicated by dotted lines is mounted on the top panel of the camera body 112. An annular zooming ring 118 is fitted around the lens barrel 114. When the zooming ring 118 is manually rotated, the optical zooming lens moves forward or backward inside the lens barrel 114 relative to the camera body 112 along the optical axis of the lens, thereby varying the optical zooming magnification.

On the rear panel of the digital camera 100 are mounted a viewfinder 120 through which the subject is viewed, a rear monitor 122 constructed, for example, from a liquid crystal display for displaying the subject image in live view mode or for presenting captured images for viewing, a four-way key pad 124 and a set button 126 used when making various settings from the menu displayed on the rear monitor 122, and a digital zooming button 128 for varying the digital zooming magnification.

In this digital camera 100, the optical zooming is adjusted between the wide angle end and the telephoto end by rotating the zooming ring 114 and, when an additional zooming is desired, the digital zooming is activated by operating the digital zooming button 128.

However, in the digital camera 100 described above, since separate members have to be operated to activate the optical zooming and the digital zooming, respectively, not only is the operation difficult to understand and cumbersome, but there is the possibility of erroneous operation.

### SUMMARY OF THE INVENTION

A primary object of the present invention is to provide an image capturing apparatus which has optical zooming and digital zooming capabilities, and which ensures extremely simple and user friendly operation while eliminating the possibility of erroneous operation.

The above object of the present invention is achieved by providing an image capturing apparatus comprising an optical zooming lens which moves in forward and backward directions relative to a body of the image capturing apparatus so as to vary shooting magnification, an imaging sensor which captures image data of a subject image focused through the optical zooming lens, a zooming ring movable around a lens barrel containing the optical zooming lens, and which varies a focal length of the optical zooming lens, a digital zooming portion which digitally enlarges the image data by reading a portion of the image data from the image data captured by the imaging sensor, a digital zooming instruction member which inputs a command to operate the digital zooming portion, a detecting portion which detects a position of the zooming ring, and a controller which controls the digital zooming portion to operate in response to a detection that the zooming ring reaches a predetermined position when the digital zooming instruction member inputs the command to operate the digital zooming portion.

These and other objects, advantages and features of the invention will become apparent from the following description thereof taken in conjunction with the accompanying drawings, which illustrate specific embodiments of the invention.

### BRIEF DESCRIPTION OF THE DRAWINGS

These and other objects, advantages and features of the invention will become apparent from the following description thereof taken in conjunction with the accompanying drawings in which:

FIG. 1(a) is a side view of a single-reflex digital camera according to the prior art;

FIG. 1(b) is a rear view of the prior art digital camera;

FIG. 2 is a front view of a single-reflex digital camera according to one embodiment of the present invention;

FIG. 3 is a side view of the digital camera of FIG. 2;

FIG. 4 is a rear-view of the digital camera of FIG. 2;

FIG. 5 is a schematic block diagram showing the internal configuration of the digital camera of FIG. 2;

FIG. 6 is a perspective view showing a cam ring with a cam groove formed therein and a pin which is synchronized with the operation of a digital zooming switch;

FIG. 7 is a diagram showing a perspective view of the cam ring containing a detecting portion for detecting the rotation angle of the cam ring, and also showing the waveforms of signals output from photo reflectors constituting the detecting portion;

FIG. 8(a) and FIG. 8(b) are diagrams for explaining a method of how the direction in which a zooming ring is operated is judged by detecting a change occurring in the state of the signal output from either one of the photo reflectors;

FIG. 9(a) is a diagram showing the condition of a main mirror in an optical viewfinder mode;

FIG. 9(b) is a diagram showing the condition of the main mirror in a live view display mode using a rear monitor;

FIGS. 10a, 10b and 10c are diagrams respectively showing a screen displayed on the rear monitor for digital zooming mode setting;

FIG. 11 is a graph showing the relationship between the rotation angle of the zooming ring and focal length in a linear mode;

FIG. 12 is a graph showing the relationship between the rotation angle of the zooming ring and focal length in a full range mode; and

FIG. 13 is a flow chart for explaining the operation of the digital camera of FIG. 2.

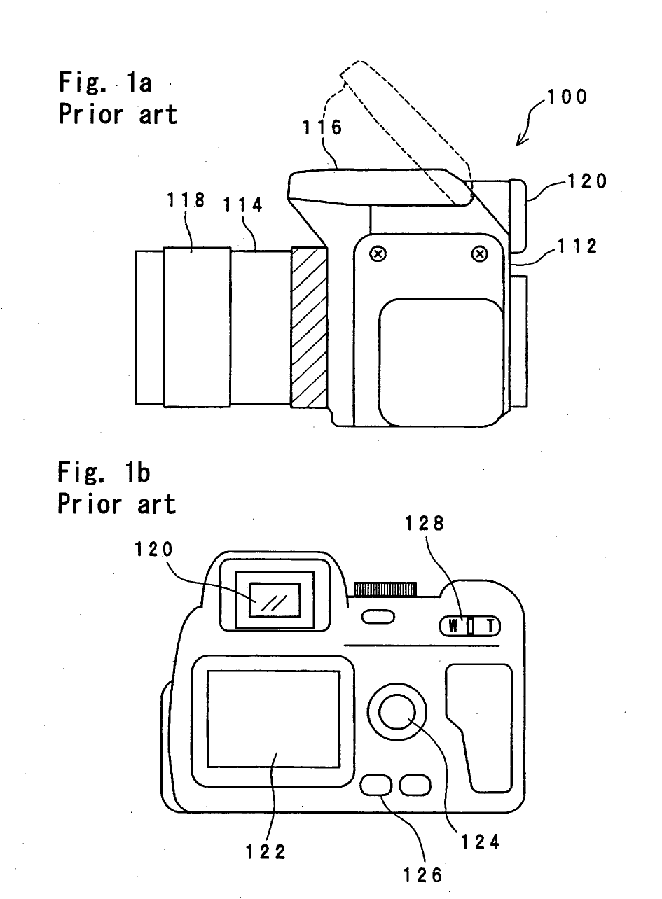

### DESCRIPTION OF THE PREFERRED EMBODIMENTS

Embodiments of an image capturing apparatus according to the present invention will be described below with reference to the accompanying drawings.

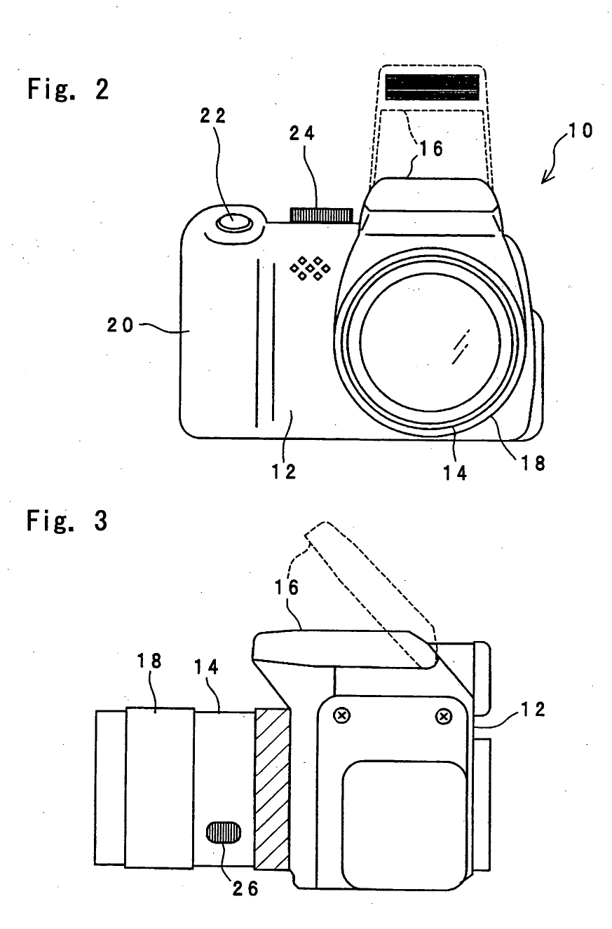

FIG. 2 is a front view of a single-reflex digital camera 10 according to one embodiment of the present invention, FIG. 3 is a side view of the digital camera 10, and FIG. 3 is a rear view of the digital camera 10.

As shown in FIG. 2, the digital camera 10 comprises a camera body 12 as a camera casing, and a cylindrically shaped lens barrel 14 which contains an optical zooming lens. A built-in flash 16 which, when activated, automatically pops up to the position indicated by dotted lines is mounted on the top panel of the camera body 12. An annular zooming ring 18 is fitted around the lens barrel 14. When the zooming ring 18 is manually rotated, the optical zooming lens moves forward or backward inside the lens barrel 14 relative to the camera body 12, the focal length thus being changed to vary the optical zooming magnification.

One end of the camera body 12 is formed as a grip 20 which is gripped by hand, and a shutter release button 22 is mounted on the top of the grip 20. A mode setting dial 24 for setting modes such as various still image shooting modes, moving image shooting mode, etc. is mounted on the top panel of the camera body 12. Further, a digital zooming switch 26, which is slid backward in the axial direction of the lens barrel 14 (i.e., in the leftward direction in FIG. 3) and is thus turned on to enable the digital zooming for operation, is mounted on an outer circumferential portion of the lens barrel 14.

The digital zooming switch 26 is not limited to a slide switch type, but other suitable type of switch (for example, a pushbutton type switch or a rotary type switch) may be employed.

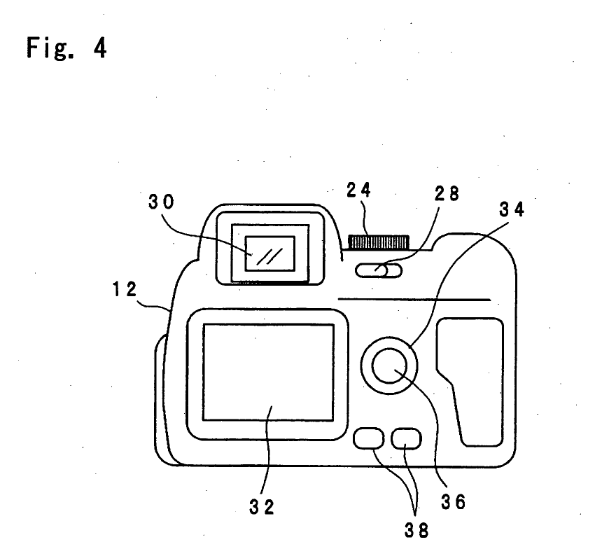

As shown in FIG. 4, on the rear panel of the camera body 12 are mounted a slide-type main switch 28 for turning on and off the power of the digital camera 10, a viewfinder 30 through which the subject is viewed, a rear monitor 32 constructed, for example, from a liquid crystal display for displaying the subject image in live view mode or for presenting captured images for viewing, a four-way key pad 34 and an enter button 36 used when making various settings from the menu displayed on the rear monitor 32, and a camera shake correction button 38 for activating and deactivating a camera shake correction function.

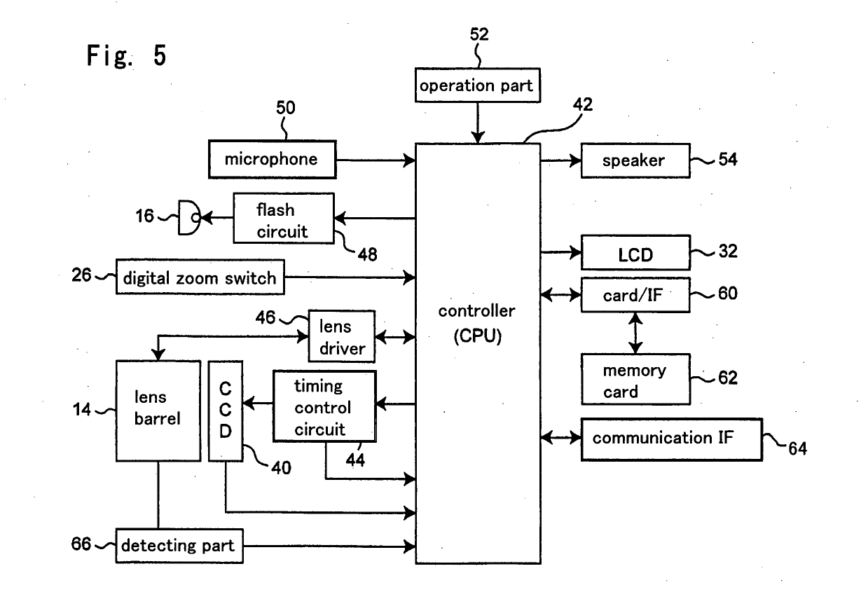

FIG. 5 is a schematic block diagram showing the internal configuration of the digital camera 10.

An optical image of the subject, introduced through the objective lens and the zooming lens in the lens barrel 14, is focused on a CCD (Charge Coupled Device) 40 which is one example of an imaging device. The CCD 40 converts the thus focused optical image of the subject into electrical image signals (signals comprising a series of pixel signals proportional to the light received at individual pixels) representing R (red), G (green), and B (blue) color components, and outputs the electrical image signals to a controller 42. A timing control circuit 44 generates a drive control signal for the CCD 40 in response to a command signal issued from the controller 42.

A lens driver 46 controls the driving of a lens group and a diaphragm member contained in the lens barrel 14, and comprises an aperture control circuit which controls the aperture of the diaphragm member, a zooming control circuit which varies zooming magnification by driving a motor, and a focus control circuit which performs focus control by driving a motor.

When the digital zooming switch 26 is set ON, an ON signal is output to the controller 42.

A flash circuit 48 controls the intensity of light that the built-in flash 16 produces for flash shooting to the prescribed flash intensity set by the controller 42.

A microphone 50 is used to gather sound during moving image shooting.

An operation portion 52 includes operating members such as the shutter release button 22, the mode setting dial 24, the main switch 28, the four-way key pad 34, the enter button 36, the camera shake correction button 38, etc., and information concerning the operation of any of these operating members is sent to the controller 42.

A speaker 54 is used to reproduce sound when playing back recorded moving images for viewing.

The liquid crystal display LCD is the rear monitor 32, and is used to present a live view display of the subject image captured by the CCD 40, reproduce recorded images for viewing, or display a menu screen or a mode setting screen when making various settings.

The controller 42 comprises, for example, a CPU, and is responsible for the overall control of image shooting and playback functions. The controller 42 includes a digital zooming portion which digitally enlarges an image by reading a portion of the image from the subject image captured by the CCD 40. The digital zooming portion is enabled for operation when the digital zooming switch 26 is set ON. A memory card 62 is connected to the controller 42 via a card interface 60. Further, the controller 42 is capable of communicating with an external device (for example, a personal computer) via a communication interface 64.

The lens barrel 14 is equipped with a detecting portion 66 as will be described later, and signals from the detecting portion 66 are input to the controller 42.

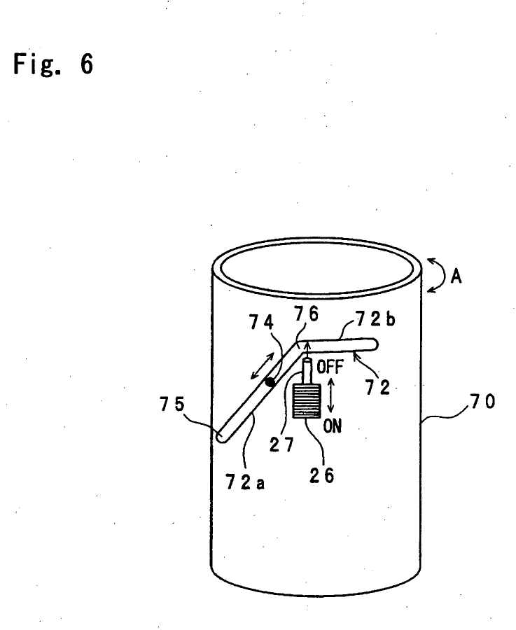

As shown in FIG. 6, the lens barrel 14 contains a cylindrically shaped cam ring 70 which is mounted concentric with the center of the barrel. The cam ring 70 is constructed to rotate in arrow direction A with the rotation of the zooming ring 18 fitted around the outer circumference of the lens barrel 14.

A cam groove 72 is formed in an outer circumferential portion of the cam ring 70. The cam groove 72 comprises a slanted groove portion 72a, which is slanted, for example, at 45 degrees relative to the circumferential direction of the cam ring 70 or the lens barrel 14, and a circumferentially extending groove portion 72b, which extends along the circumferential direction.

One or more optical zooming lenses are housed in the cam ring 70, and a cam follower pin 74 fixed to a lens frame member holding the optical zooming lens(es) is engaged in the cam groove 72. Accordingly, when the cam ring 70 is rotated by operating the zooming ring 18, the cam follower pin 74 moves along the slanted groove portion 72a of the cam groove 72, causing the lens frame member holding the optical zooming lens(es) to move along the optical axis thereof, and hence the optical zooming lens(es) to move forward or backward relative to the camera body 12, thereby varying the optical zooming magnification.

Here, when the cam follower pin 74 is located at one end 75 of the slanted groove portion 72a, the optical zooming lens(es) is at the wide angle end, the position closest to the camera body 12; on the other hand, when the cam follower pin 74 is located at the other end 76 of the slanted groove portion 72a, the optical zooming lens(es) is at the telephoto end, the position farthest from the camera body 12.

As shown in FIG. 6, a pin 27 as a restricting member is connected to the digital zooming switch 26 mounted on an outer circumferential portion of the lens barrel 14. When the digital zooming switch 26 is slid into the OFF position, the pin 27 engages in the cam groove 27 at or near the position where the slanted groove portion 72a and the circumferentially extending groove portion 72b of the cam groove 72 meet; on the other hand, when the digital zooming switch 26 is slid into the ON position, the pin 27 disengages from the cam-groove 72.

Accordingly, when the digital zooming switch 26 is OFF, since the cam follower pin 74 strikes the pin 27 at the telephoto end position of the optical zooming, the zooming ring 18 and the cam ring 70 are prevented from being further rotated beyond that position.

On the other hand, when the digital zooming switch 26 is ON, since the pin 27 is disengaged from the cam groove 72, the cam follower pin 74 is allowed to move along the cam groove 72 from the slanted groove portion 72a into the circumferentially extending groove portion 72b, thus allowing the zooming ring 18 and the cam ring 70 to be further rotated beyond the telephoto end position of the optical zooming.

Here, if the zooming ring 18 is further rotated beyond the telephoto end position of the optical zooming, since the cam follower pin 74 just moves along the circumferentially extending groove portion 72b of the cam groove 72, the optical zooming lens stays at the telephoto end position, and the optical zooming is thus maintained at its maximum magnification. Subsequently, when the zooming ring 18 is rotated so as to move the cam follower 74 into the circumferentially extending groove portion 72b of the cam groove 72, since the digital zooming switch 26 is in the ON position and the digital zooming is thus enabled for operation, the digital zooming is activated by detecting that the zooming ring 18 has been further rotated beyond the telephoto end position of the optical zooming.

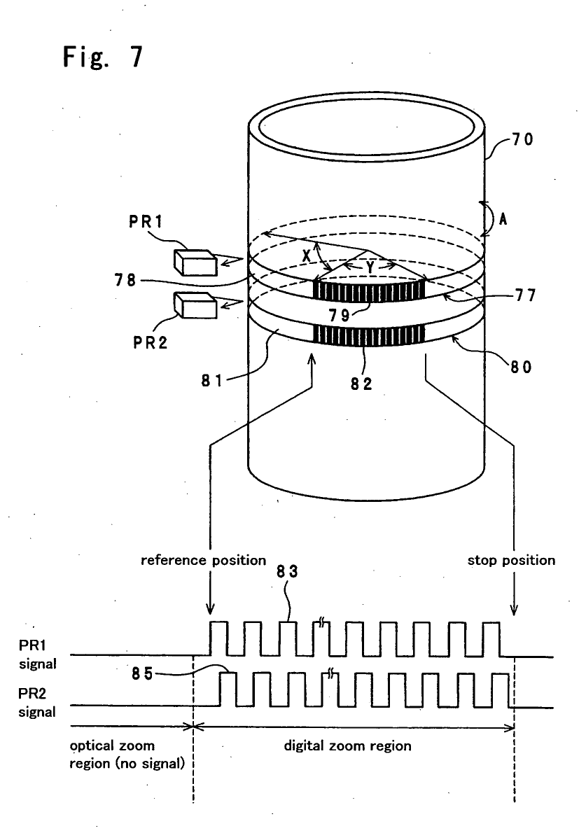

Further, as shown in FIG. 7(a), two band-like patterns 77 and 80 extending in parallel in the circumferential direction are formed on the outer circumferential surface of the cam ring 70. The major portions of the band-like patterns 77 and 80 are formed, for example, as white patterns 78 and 81 having high optical reflectivity, but the portions lying within a certain angular range are formed, for example, as black-and-white patterns 79 and 82 each having high reflectivity sections alternating with low reflectivity sections. Photo reflectors PR1 and PR2 for projecting light and detecting reflected light are mounted in the lens barrel 14 at positions opposite the respective band patterns 77 and 80.

The band patterns 77 and 80 and the photo reflectors PR1 and PR2 together constitute the detecting portion 66.

In the band patterns 77 and 80, the portions lying within a first angular range X correspond to the optical zooming region defined by the white patterns 78 and 81; within this range, the photo reflectors PR1 and PR2 do not output any signals to the controller 42. As a result, the controller 42 can determine that the moving range of the zooming ring 18 in this case is in the optical zooming region (that is, the range within which the cam follower pin 74 moves along the slanted groove portion 72a of the cam groove 72).

On the other hand, the portions lying within a second angular range Y correspond to the digital zooming region defined by the black-and-white patterns 79 and 82; within this range, the photo reflectors PR1 and PR2 respectively output rectangular pulse signals 83 and 85 to the controller 42. As a result, the controller 42 can determine that the moving range of the zooming ring 18 in this case is in the digital zooming region (that is, the range within which the cam follower pin 74 moves along the circumferentially extending groove portion 72b of the cam groove 72), and can also detect the amount of rotation of the zooming ring 18 from the number of occurrences of the respective rectangular pulse signals 83 and 85.

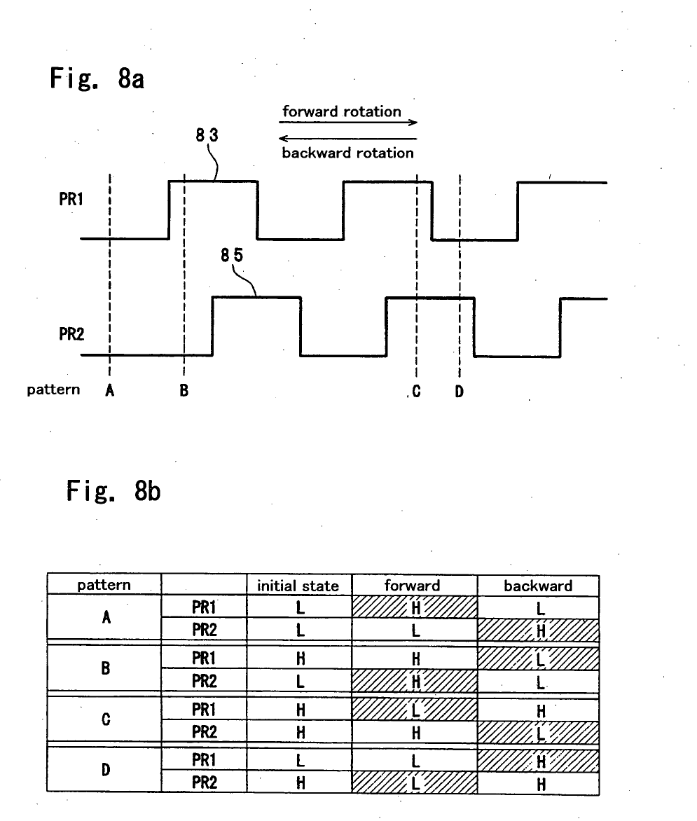

In this case, since the pattern positions of the black-and-white patterns 79 and 82 are displaced from each other in the circumferential direction, the timing of the rectangular pulse signal 83 output from the photo reflector PR1 is somewhat displaced from the timing of the rectangular pulse signal 85 output from the photo reflector PR2. To describe more specifically, in the initial state, there are only four kinds of patterns A, B, C, and D, as shown in FIGS. 8(a) and (b). That is, the pattern A in which the signals from the photo reflectors PR1 and PR2 are both low (L), the pattern B in which the signal from the photo reflector PR1 is high (H) while the signal from the photo reflector PR2 is low (L), the pattern C in which the signals from the photo reflectors PR1 and PR2 are both high (H), and the pattern D in which the signal from the photo reflector PR1 is low (L) while the signal from the photo reflector PR2 is high (H). When the zooming ring 18 is rotated forward or backward from the initial state of any one of the four kinds of patterns, the signal state of either one of the photo reflectors changes earlier than the signal state of the other. It can thus be determined whether the zooming ring 18 has been rotated forward or backward, by checking which photo reflector has changed signal state earlier than the other.

Here, the detecting portion 66 for detecting the amount of rotation of the zooming ring 18 when the rotating range of the zooming ring 18 is in the digital zooming region is not limited to the above-described configuration, but may be constructed using, for example, an encoder for reading electrical ON/OFF patterns and an electrical contact.

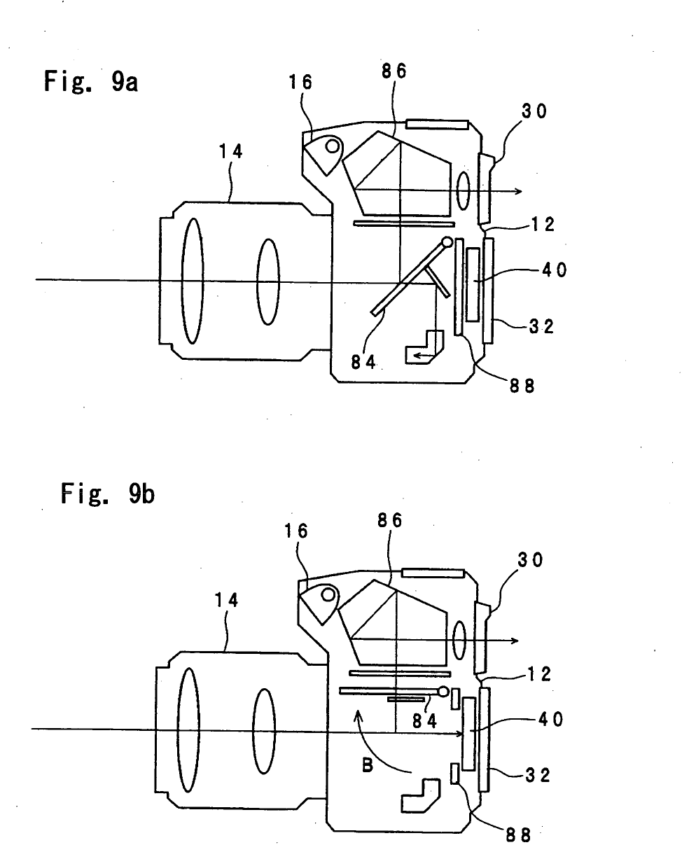

When the digital camera 10 is used in the optical zooming region, the user can view the subject image through the viewfinder 30. That is, as shown in FIG. 9(a), the subject image introduced through the lens group in the lens barrel 14 into the camera body 12 is first reflected upward by a main mirror 84 and then reflected twice in a pentaprism 86 for introduction into the viewfinder 30. At this time, the CCD 40 is covered by a closed shutter 88.

On the other hand, when the digital camera 10 is used in the digital zooming region, the user can view the subject image in the live view mode on the rear monitor 32. That is, in the live view mode, since the main mirror 84 is flipped up in arrow direction B and the shutter 88 is opened, as shown in FIG. 8(b), the subject image introduced through the lens group in the lens barrel 14 into the camera body 12 is captured by the CCD 40, and the image captured by the CCD 40 is displayed on the rear monitor 32 under control of the controller 42.

Here, when the digital camera 10 is used in the optical zooming region, if the shutter release button 22 on the top of the camera body 12 is pressed, the main mirror 84 is flipped up and the shutter 88 is opened as shown in FIG. 9(b), and the subject image is thus captured by the CCD 40.

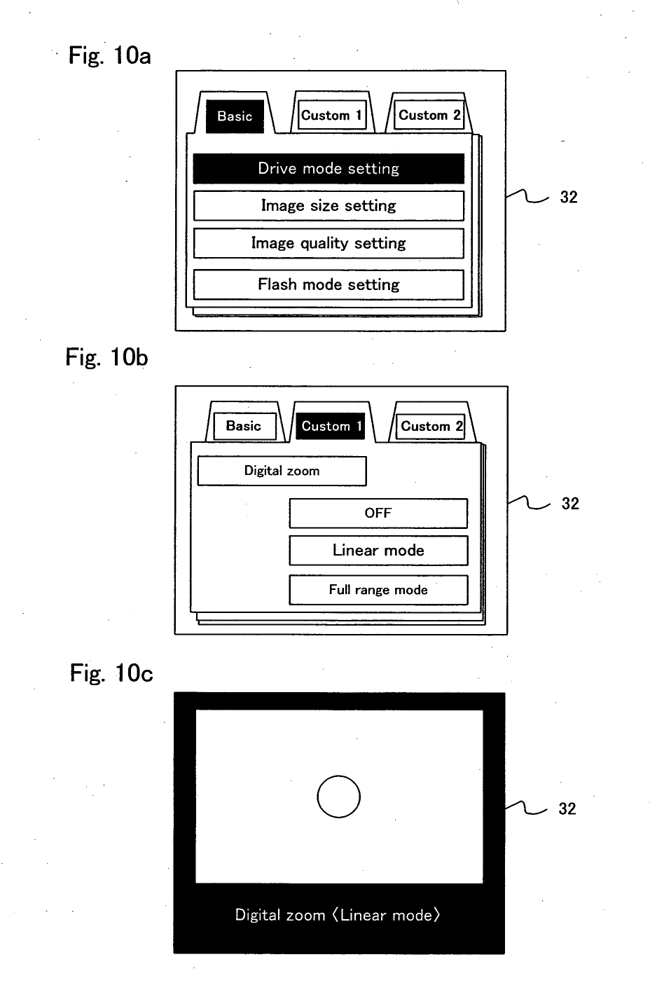

In the digital camera 10 of the present invention, either a linear mode or a full range mode can be selected for the digital zooming. First, the menu screen is displayed on the rear monitor 32, as shown in FIGS. 10a and 10b, and “Custom 1” is selected from the menu screen by operating the four-way key pad 34 and the enter button 36; then, either the linear mode or the full range mode is selected from the “Custom 1” screen by operating the four-way key pad 34 and the enter button 36.

The selected mode is displayed at the bottom of the rear monitor 32.

The linear mode here refers to the mode in which the rate of change of the digital zooming magnification with respect to the rotation angle (i.e., the amount of rotation) of the zooming ring 18 is set equal to the rate of change of the optical zooming magnification to provide, for example, a maximum digital zooming magnification of 1.33 times as shown in FIG. 11, when it is assumed that the rotation angle range from 0 to 80 degrees relative to the initial position of the zooming ring 18 is the optical zooming region and the range from 80 to 120 degrees is the digital zooming region.

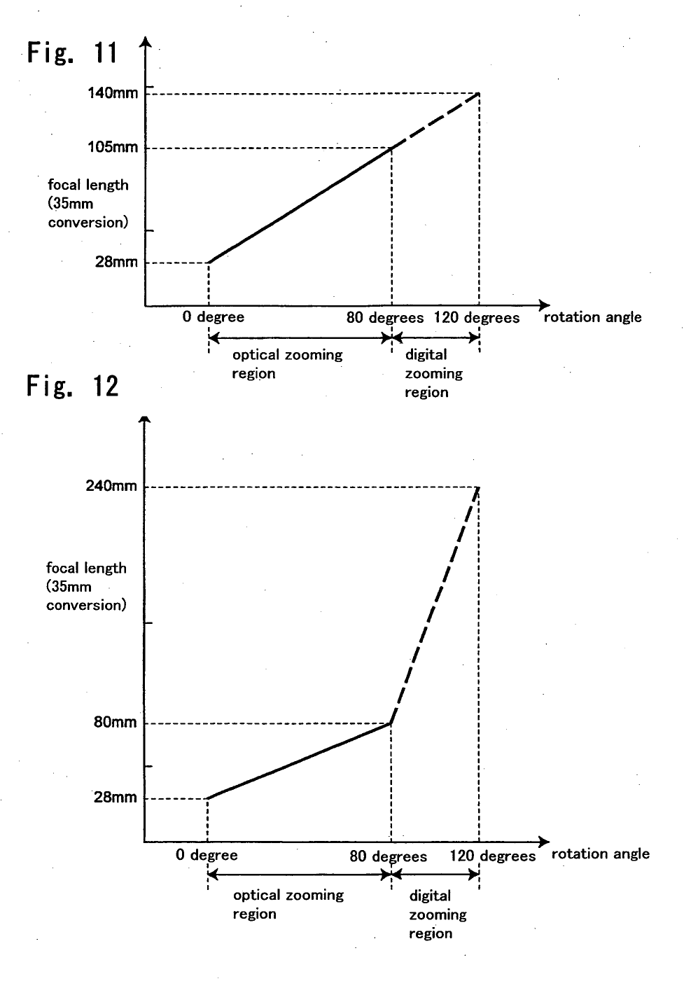

By contrast, the full range mode refers to the mode in which the rate of change of the digital zooming magnification with respect to the rotation angle (i.e., the amount of rotation) of the zooming ring 18 is set larger than the rate of change of the optical zooming magnification to provide, for example, a maximum digital zooming magnification of 3 times as shown in FIG. 12, when it is assumed that the rotation angle range from 0 to 80 degrees relative to the initial position of the zooming ring 18 is the optical zooming region and the range from 80 to 120 degrees is the digital zooming region. In the full range mode, there are cases where the rate of change of the digital zooming magnification is smaller than the rate of change of the optical zooming magnification, depending on the relationship between the optical zooming magnification and the digital zooming magnification.

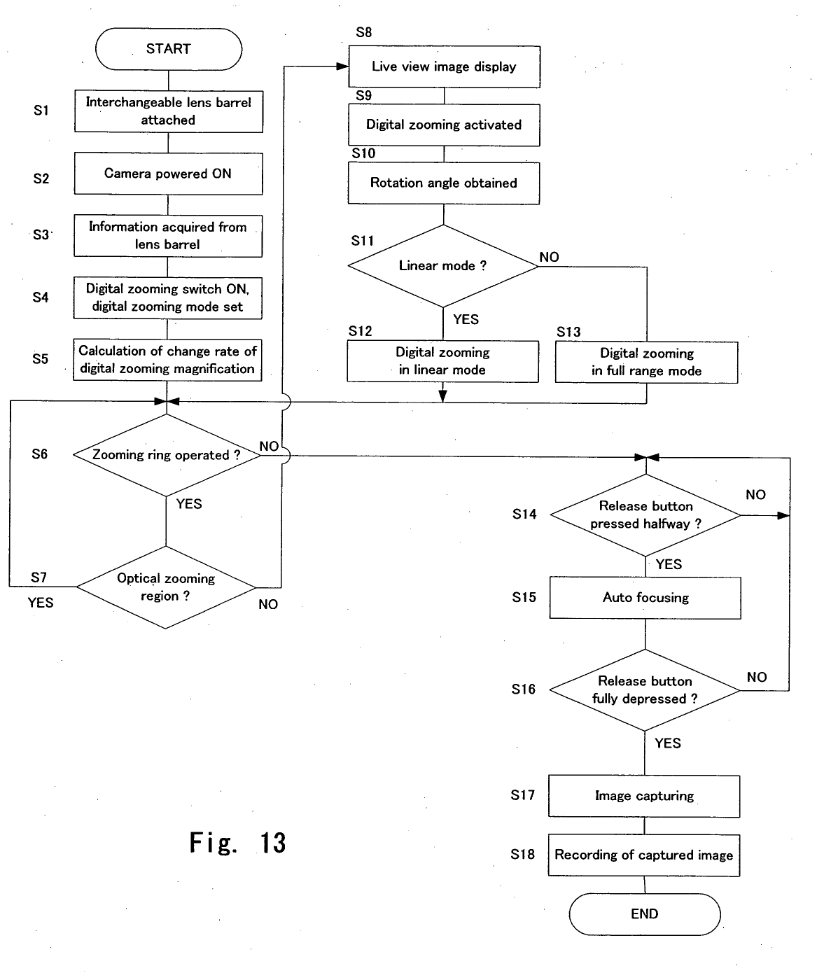

Next, the operation of the digital camera 10 having the above configuration will be described with reference to the flow chart of FIG. 13. The flow chart here deals with the digital camera 10 of the type in which the lens barrel 14 is interchangeable on the camera body 12.

When the interchangeable lens barrel 14 is attached to the camera body 12 (step S1), and the camera is powered on by operating the main switch 28 (step S2), the controller 42 in the camera body 12 communicates with the ROM built in the lens barrel 14 to acquire information stored in the ROM, such as information concerning the focal length and information concerning the rate of change of the optical zooming magnification with respect to the amount of rotation of the zooming lens 18 (step S3).

Then, when the digital zooming switch 26 is set ON, and either the linear mode or the full range mode is selected as the digital zooming mode by user operation (step S4), the controller 42 calculates the rate of change of the digital zooming magnification that matches the selected mode (step S5).

When the digital zooming switch 26 is set ON, the digital zooming portion of the controller 42 is enabled for operation, and the pin 27 connected to the digital zooming switch 26 is disengaged from the cam groove 72 of the cam ring 70 in synchronization with the ON operation, thus allowing the zooming ring 18 to be further rotated beyond the telephoto end position of the optical zooming. As a result, when the zooming ring 18 is rotated beyond the telephoto end position of the optical zooming, the digital zooming is activated.

Thereafter, the controller 42 determines whether the zooming ring 18 has been rotated for operation (step S6). Whether the zooming ring 18 has been operated or not can be detected by detecting the change in the focal length of the image capturing lens when the zooming ring 18 is in the optical zooming region, or by detecting the input signals from the photo reflectors PR1 and PR2 when the zooming ring 18 is in the digital zooming region. Conventionally, the present focal length of the optical zooming has to be detected as shooting information even in the case of manual zooming; in the present embodiment, this focal length is detected using an encoder not shown.

If it is determined that the zooming ring 18 has been operated, then it is determined whether the zooming ring 18 is located in the optical zooming region (step S7). This determination can be made by detecting the presence or absence of the input signals from the photo reflectors PR1 and PR2, as described above.

The steps S6 and S7 are repeated as long as the zooming ring 18 is being operated in the optical zooming region. When the operation of the zooming ring 18 in the optical zooming region is completed, it is determined whether the shutter release button 22 is pressed halfway (step S14); if it is pressed halfway, auto focusing is performed (step S15). Next, it is determined whether the shutter release button 22 is fully depressed or not (step S16); if it is fully depressed, image capturing is performed (step S17), and the captured image is recorded (step S18). Here, the steps S14, S15, and S16 are repeated until it is determined that the shutter release button 22 is fully depressed.

On the other hand, if it is determined in step S7 that the zooming ring 18 is not located in the optical zooming region (that is, it has moved into the digital zooming region), the controller 42 switches the subject image viewing means from the optical viewfinder 30 to the rear monitor 32 to produce a live view display (step S8), and activates the digital zooming (step S9). Then, the controller 42 acquires the rotation angle (i.e., the amount of rotation) of the zooming ring 18 detected by the photo reflectors PR1 and PR2 (step S10).

Next, the controller 42 determines whether the mode is set to the linear mode or not (step S11). If the mode is set to the linear mode, digital zooming is performed by determining the digital zooming magnification that matches the detected rotation angle of the zooming ring 18, based on the rate of change calculated in step S5 for the linear mode (step S12). On the other hand, if the mode is set to the full range mode, digital zooming is performed by determining the digital zooming magnification that matches the detected rotation angle of the zooming ring 18, based on the rate of change calculated in step S5 for the full range mode (step S13). In either mode, a live view display of the digitally zoomed subject image is produced on the rear monitor 32.

The above steps S8 to S13 are repeated until the operation of the zooming ring 18 in the digital zooming region is completed (step S6 or S7).

When the operation of the zooming ring 18 in the digital zooming region is completed, it is determined whether the shutter release button 22 is pressed halfway (step S14); if it is pressed halfway, auto focusing is performed (step S15). Next, it is determined whether the shutter release button 22 is fully depressed or not (step S16); if it is fully depressed, image capturing is performed (step S17), and the captured image is recorded (step S18). Here, the steps S14, S15, and S16 are repeated until it is determined that the shutter release button 22 is fully depressed.

In the case of a camera in which the lens barrel 14 is not an interchangeable type, since the focal length of the zooming lens and the optical zooming magnification are invariant and, therefore, need only be prestored in the controller 42, the steps S1 and S3 in the flow chart of FIG. 12 are not necessary.

As described above, according to the digital camera 10 of the present embodiment, when the digital zooming switch 26 is ON, a smooth transition can be made from the optical zooming to the digital zooming by just operating the zooming ring 18, and the camera thus achieves extremely simple and user friendly operation while eliminating the possibility of erroneous operation.

The present invention is not limited to the portionicular embodiment described above, but various modifications can be made.

For example, in the above digital camera 10, the zooming ring 18 has been described as being rotated for operation, but alternatively, the camera may be constructed so that the zooming ring 18 is manually moved rectilinearly in the direction parallel to the optical axis of the zooming lens. In that case, the groove for guiding the cam follower pin 74 attached to the lens frame member holding the zooming lens is formed in the shape of a straight line, and the pin 27 as the restricting member engages in the straight-line groove at an intermediate point along the length thereof.

Further, in the above digital camera 10, the digital zoominging switch 26 has been described as being provided on the lens barrel 14, but alternatively, a pushbutton type digital zoominging switch 26 may be provided, for example, on the camera body 12. In that case, it is preferable that the pin 27 as the restricting member be operated, for example, by an electric driving means such as a solenoid, in synchronization with the ON operation of the digital zoominging switch 26.

The restricting member for restricting the rotation of the zooming ring 18 at the telephoto end position of the optical zooming is not limited to the pin 27, but may be constructed from any other suitable means such as a lever, a block, or a rod member, and the motion to be given to the restricting member to cause it to engage in the cam groove 70 is not limited to rectilinear motion, but it may be constructed to engage in the cam groove 70 by being rotated.

Further, in the above digital camera 10, when the digital zooming is activated, the subject image has been presented for viewing as a live view display on the rear monitor 32, but alternatively, a small display device may be provided within the camera body 12 so that the digitally zoomed subject image displayed on the small display device can be viewed through the viewfinder 30 by switching the viewfinder 30 from the optical viewfinder to the digital viewfinder. In that case, even when the zooming mode is switched from the optical zooming to the digital zooming, the user can continue to view the subject image through the viewfinder 30 without having to take his eye off the viewfinder 30.

Although the present invention has been fully described by way of examples with reference to the accompanying drawings, it is to be noted here that various changes and modifications will be apparent to those skilled in the art. Therefore, unless otherwise such changes and modifications deportion from the scope of the present invention, they should be construed as being included therein.

What is claimed is:

1. An image capturing apparatus comprising:
an optical zooming lens which moves in forward and backward directions relative to a body of the image capturing apparatus so as to vary shooting magnification;
an imaging sensor which captures image data of a subject image focused through said optical zooming lens;
a zooming ring movable around a lens barrel containing the optical zooming lens, and which varies a focal length of the optical zooming lens;
a digital zooming portion which digitally enlarges the image data by reading a portion of the image data from the image data captured by the imaging sensor;
a digital zooming instruction member which inputs a command to operate said digital zooming portion;
a detecting portion which detects a position of said zooming ring; and
a controller which controls the digital zooming portion to operate in response to a detection that the zooming ring reaches a predetermined position when said digital zooming instruction member inputs the command to operate the digital zooming portion.

2. An image capturing apparatus as claimed in claim 1, wherein said zooming ring is allowed to be further moved beyond a telephoto end position of optical zooming and thereby to activate digital zooming when said digital zooming instruction member inputs the command to operate the digital zooming portion.

3. An image capturing apparatus as claimed in claim 2, wherein said detecting portion detects an amount of movement of the zooming ring which is moved beyond the telephoto end position, and said controller operates the digital zooming portion based on a signal from the detecting portion and determines digital zooming magnification that matches the amount of movement of the zooming ring.

4. An image capturing apparatus as claimed in claim 2, further comprising:
restricting member which restricts movement of the zooming ring so as to prevent the zooming ring to be further moved beyond the telephoto end position of optical zooming, and which, in synchronization with an operation of the digital zooming instruction member, allows the zooming ring to be further moved beyond the telephoto end position.

5. An image capturing apparatus as claimed in claim 4, wherein said restricting member includes a pin which engages in a cam groove along which the optical zooming lens is guided in the forward and backward directions.

6. An image capturing apparatus as claimed in claim 5, wherein said cam groove has a slanted groove portion which is slanted relative to a circumferential direction, and along which the optical zooming lens is guided in the forward and backward directions within a range from the wide angle end to the telephoto end of the optical zooming when the zooming ring is in an optical zooming region, and a circumferentially extending groove portion which holds the optical zooming lens at the telephoto end position when the zooming ring is in a digital zooming region.

7. An image capturing apparatus as claimed in claim 1, wherein the digital zooming instruction member is provided at the lens barrel.

8. An image capturing apparatus as claimed in claim 1, wherein the digital zooming instruction member is provided at the body of the image capturing apparatus.

9. An image capturing apparatus as claimed in claim 1, wherein the lens barrel is interchangeable on the camera body.

10. An image capturing apparatus as claimed in claim 3, further comprising:
a setting member which sets either of a linear mode or a full range mode in a digital zooming region, said linear mode wherein the rate of change of the digital zooming magnification with respect to the amount of movement of the zooming ring is equal to the rate of change of the optical zooming magnification, and said full range mode wherein the rate of change of the digital zooming magnification is different from the rate of change of the optical zooming magnification.

11. An image capturing apparatus as claimed in claim 1, wherein the zooming ring is rotated.

12. An image capturing apparatus as claimed in claim 1, wherein the zooming ring is moved rectilinearly in a direction parallel to an optical axis of the zooming lens.

13. An image capturing apparatus as claimed in claim 1, wherein the detecting portion includes an optical sensor which optically detects the position of the zooming ring.

14. An image capturing apparatus as claimed in claim 1, further comprising:
a display portion which displays a captured image, wherein the controller controls said display portion to display the captured image in response to the detection that the zooming ring reaches the predetermined position.

15. An image capturing apparatus as claimed in claim 14 wherein said display portion is provided at rear of the body of the image capturing apparatus.

16. An image capturing apparatus as claimed in claim 14, further comprising:
a viewfinder through which the subject is viewed, wherein the display portion is provided inside of the body of the image capturing apparatus, and the captured image is viewed through the viewfinder.

17. A zooming method performed in an image capturing apparatus comprising an optical zooming lens movable in forward and backward directions relative to a body of the image capturing apparatus so as to vary shooting magnification, an imaging sensor which captures image data of a subject image focused through said optical zooming lens and a zooming ring movable around a lens barrel containing the optical zooming lens which varies a focal length of the optical zooming lens, said zooming method comprising the steps of:
instructing a digital zooming operation which digitally enlarges the image data by reading a portion of the image data from the image data captured by the imaging sensor;
detecting a position of the zooming ring; and
starting the digital zooming operation in response to a detection that the zooming ring reaches a predetermined position.

18. A method as claimed in claim 17, further comprising the step of:
displaying a captured image in a display portion provided at the image capturing apparatus.
